(19) United States
(12) Patent Application Publication
(10) Pub. No.: US 2006/0076881 A1
(43) Pub. Date: Apr. 13, 2006

(54) Display apparatus

(76) Inventors: Hyun-Jin Kim, Seoul (KR); Seok-Hyun Nam, Seoul (KR); Don-Chan Cho, Seongnam-si (KR); Sang-Yu Lee, Yongin-si (KR)

Correspondence Address: CANTOR COLBURN, LLP, 55 GRIFFIN ROAD SOUTH, BLOOMFIELD, CT, 06002, US

(21) Appl. No.: 11/247,884

(22) Filed: Oct. 10, 2005

(30) Foreign Application Priority Data
Oct. 8, 2004 (KR) 2004-80534

(51) Int. Cl. H01J 63/04; H01J 1/62

(52) U.S. Cl. 313/496

(57) ABSTRACT

A display apparatus includes a top substrate, a middle substrate, and a bottom substrate. The top substrate includes a first substrate. The middle substrate includes a second substrate, an anode electrode and a fluorescent layer. The second substrate includes an upper surface facing the first substrate and a lower surface that is opposite to the upper surface. An array layer is formed on either the upper surface of the second substrate or a lower surface of the first substrate. The anode electrode is formed on the lower surface of the second substrate. The fluorescent layer is formed on the anode electrode. The bottom substrate includes a third substrate and a cathode electrode formed on the third substrate such that the cathode electrode faces the fluorescent layer. Therefore, a thickness may be reduced and luminance of a light may be enhanced.

This application claims priority to Korean Patent Application No. 2004-80534, filed on Oct. 8, 2004 and all the benefits accruing therefrom under 35 U.S.C. §119, and the contents of which in its entirety are herein incorporated by reference.

### BACKGROUND OF THE INVENTION

1. Field of the Invention

The present invention relates to a display apparatus. More particularly, the present invention relates to a liquid crystal display apparatus employing an electroluminescent type backlight assembly.

2. Description of the Related Art

Generally, a liquid crystal display (“LCD”) apparatus includes an LCD panel that displays an image and a backlight assembly that provides the LCD panel with light.

A conventional backlight assembly employs a cold cathode fluorescent lamp (“CCFL”). The conventional backlight assembly employing the CCFL may be classified either as an edge illumination type backlight assembly or a direct illumination type backlight assembly according to a position of the CCFL.

According to the edge illumination type backlight assembly, one or two CCFLs are disposed at a side face of a light guide plate. Therefore, light generated from the CCFL or CCFLs enters the light guide plate through the side face, and exits the light guide plate through an upper face of the light guide plate to advance toward the LCD panel.

According to the direct illumination type backlight assembly, a plurality of CCFLs are disposed under a diffusion plate. Therefore, light generated from the CCFLs is diffused by the diffusion plate and advances toward the LCD panel disposed over the diffusion plate.

According to the conventional backlight assembly, light decays when the light passes through either the light guide plate or the diffusion plate. As a result, both luminance and light-using efficiency are lowered. Further, the conventional backlight assembly has poor luminance uniformity, and a cost of manufacturing the conventional backlight assembly is high, thereby lowering productivity.

Furthermore, the conventional backlight assembly has a thick thickness, which also increases a thickness of the display apparatus employing the conventional backlight assembly.

### BRIEF SUMMARY OF THE INVENTION

The present invention provides a display apparatus having thin thickness and high luminance.

In an exemplary embodiment of a display apparatus, the display apparatus includes a top substrate, a middle substrate, and a bottom substrate. The top substrate includes a first substrate. The middle substrate includes a second substrate, an array layer, an anode electrode, and a fluorescent layer. The second substrate includes an upper surface facing the first substrate and a lower surface opposite the upper surface. The array layer is formed on the upper surface of the second substrate. The anode electrode is formed on the lower surface of the second substrate. The fluorescent layer is formed on the anode electrode. The bottom substrate includes a third substrate and a cathode electrode formed on the third substrate such that the cathode electrode faces the fluorescent layer.

In another exemplary embodiment of a display apparatus, the display apparatus includes a top substrate, a middle substrate, and a bottom substrate. The top substrate includes a first substrate and an array layer formed on the first substrate. The middle substrate includes a second substrate, an anode electrode, and a fluorescent layer. The second substrate includes an upper surface facing the first substrate and a lower surface opposite the upper surface. The anode electrode is formed on the lower surface. The fluorescent layer is formed on the anode electrode. The bottom substrate includes a third substrate and a cathode electrode formed on the third substrate such that the cathode electrode faces the fluorescent layer.

In another exemplary embodiment of a display apparatus, the display apparatus includes a top substrate, a middle substrate including a fluorescent layer, and a bottom substrate spaced from the middle substrate and including a cathode electrode facing the fluorescent layer, the fluorescent layer emitting a light when a voltage is applied to the cathode electrode.

According to the display apparatuses of the present invention, a light source is integrally formed with an LCD panel. Therefore, thickness is reduced and luminance is enhanced.

### BRIEF DESCRIPTION OF THE DRAWINGS

The above and other features and advantages of the present invention will become more apparent by describing in detailed exemplary embodiments thereof with reference to the accompanying drawings, in which:

FIG. 1 is a schematic cross-sectional view illustrating a first exemplary embodiment of a display apparatus according to the present invention;

FIG. 2 is an enlarged view illustrating portion ‘A’ in FIG. 1;

FIG. 3 is an enlarged view illustrating portion ‘B’ in FIG. 1;

FIG. 4 is a schematic cross-sectional view illustrating a second exemplary embodiment of a display apparatus according to the present invention;

FIG. 5 is a schematic cross-sectional view illustrating a third exemplary embodiment of a display apparatus according to the present invention;

FIG. 6 is a schematic cross-sectional view illustrating a fourth exemplary embodiment of a display apparatus according to the present invention; and

FIG. 7 is a schematic cross-sectional view illustrating a fifth exemplary embodiment of a display apparatus according to the present invention.

### DETAILED DESCRIPTION OF THE INVENTION

Hereinafter, the embodiments of the present invention will be described in detail with reference to the accompanied drawings. In the drawings, the thickness of layers, films, and regions are exaggerated for clarity. Like numerals refer to like elements throughout. It will be understood that when an element such as a layer, film, region, or substrate is referred to as being “on” another element, it can be directly on the other element or intervening elements may also be present.

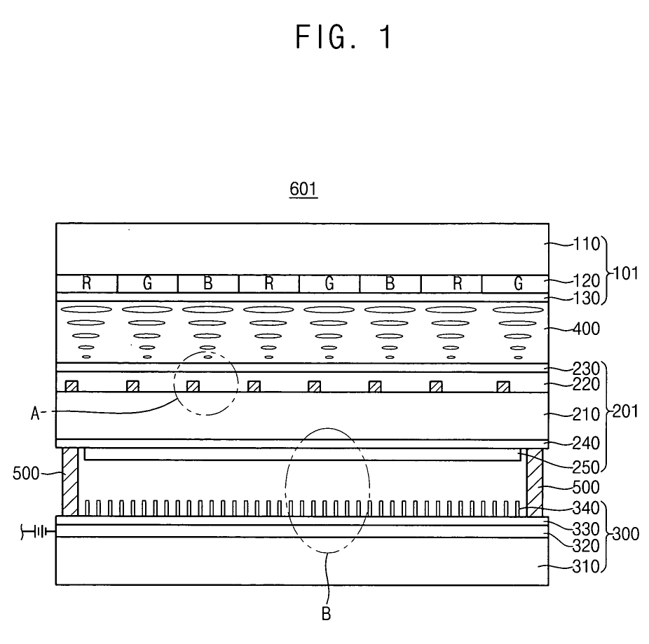

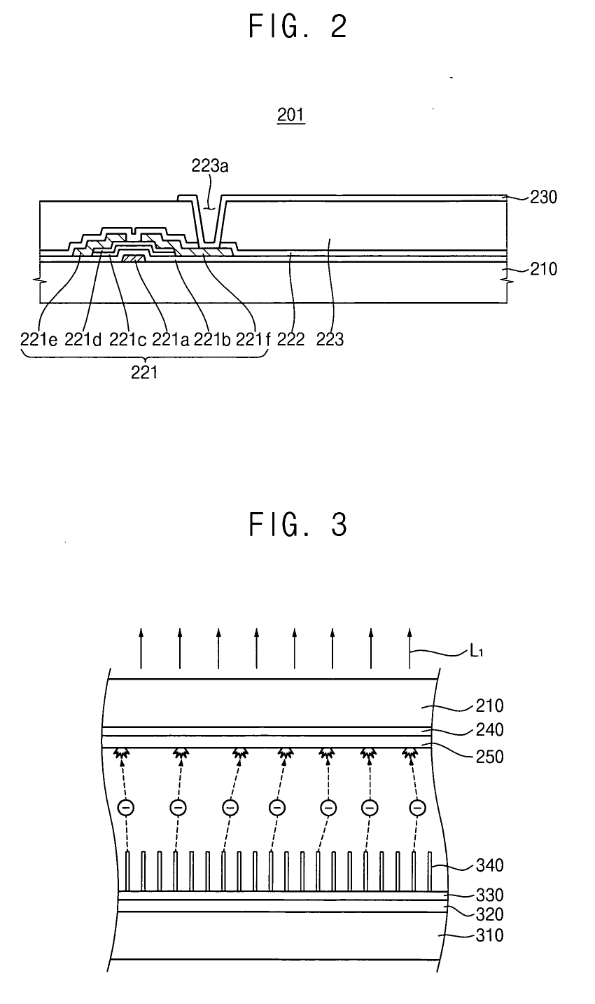

FIG. 1 is a schematic cross-sectional view illustrating a first exemplary embodiment of a display apparatus according to the present invention. FIG. 2 is an enlarged view illustrating portion ‘A’ in FIG. 1, and FIG. 3 is an enlarged view illustrating portion ‘B’ in FIG. 1.

Referring to FIG. 1, a display apparatus 601 includes a top substrate 101, a middle substrate 201, and a bottom substrate 300.

The top substrate 101 includes a first substrate 110, a color filter layer 120, and a common electrode 130. The color filter layer 120 is formed on the first substrate 110 such that the color filter layer 120 faces the middle substrate 201. The color filter layer 120 includes red, green, and blue color filters R, G and B. The common electrode 130 includes an optically transparent and electrically conductive material such as, but not limited to, indium tin oxide (“ITO”), indium zinc oxide (“IZO”), etc. The common electrode 130 is formed on the color filter layer 120, and the color filter layer 120 is disposed between the first substrate 110 and the common electrode 130. The common electrode 130 has uniform thickness.

The middle substrate 201 includes a second substrate 210, an array layer or substrate 220, a pixel electrode 230, an anode electrode 240, and a fluorescent layer 250. The array layer 220 is formed on the second substrate 210 such that the array layer 220 faces the top substrate 101. The array substrate 220 is positioned between the pixel electrode 230 and the second substrate 210. The anode electrode 240 is positioned between the second substrate 210 and the fluorescent layer 250.

Referring to FIG. 2, the array substrate 220 includes a plurality of thin film transistors (“TFTs”) 221 (only one illustrated for clarity), a protection layer 222 that protects the TFTs 221, and an organic insulation layer 223 disposed on the protection layer 222.

Each of the TFTs 221 includes a gate electrode 221a, a gate insulation layer 221b, an active layer 221c, an ohmic contact layer 221d, a source electrode 221e, and a drain electrode 221f.

The gate electrode 221a is formed on the second substrate 210. The gate insulation layer 221b is formed on the second substrate 210 having the gate electrode 221a formed thereon such that the gate insulation layer 221b covers the gate electrode 221a. The active layer 221c is formed on the gate insulation layer 221b in an area of the gate electrode 221a such that the active layer 221c overlaps the gate electrode 221a. The ohmic contact layer 221d is formed on the active layer 221c. The source electrode 221e and the drain electrode 221f are formed on the ohmic contact layer 221d such that the source electrode 221e and the drain electrode 221f are spaced apart from each other. The source electrode 221e and the drain electrode 221f extend from the gate insulation layer 221b to an area overlapping the ohmic contact layer 221d.

The protection layer 222 and the organic insulation layer 223 include a contact hole 223a that exposes the drain electrode 221f. A portion of the organic insulation layer 223 and a portion of the protection layer 222 are removed to form the contact hole 223a. The pixel electrode 230 includes an optically transparent and electrically conductive material such as, but not limited to ITO, IZO, etc. The pixel electrode 230 is formed on the organic insulation layer 223 and within the contact hole 223a. The pixel electrode 230 is electrically connected to the drain electrode 221f through the contact hole 223a. The pixel electrode 230 has uniform thickness.

Referring again to FIG. 1, the anode electrode 240 is formed on the second substrate 210 such that the anode electrode 240 faces the bottom substrate 300.

The fluorescent layer 250 is formed on a side of the anode electrode 240 that faces the bottom substrate 300.

A liquid crystal layer 400 is interposed between the top substrate 101 and the middle substrate 201. The liquid crystal layer 400 includes, for example, twisted nematic liquid crystal molecules, where the liquid crystal molecules have, for example, a helical structure (alternatively termed “twisted”), and lie on a plate. In a normal state, polarized light can pass directly through these crystals, giving a clear appearance. However, when an electric field is applied, light cannot pass, giving a darkened appearance.

The bottom substrate 300 includes a third substrate 310, a cathode electrode 320, a catalyst metal layer 330, and a plurality of tips 340.

The cathode electrode 320 is formed on the third substrate 310. A specific voltage is applied to the cathode electrode 320 via the illustrated voltage supply line.

The catalyst metal layer 330 is formed on the cathode electrode 320 such that the cathode electrode 320 is interposed between the third substrate 310 and the catalyst metal layer 330. The tips 340 are formed on the catalyst metal layer 330.

The tips 340 include carbon nano tube (“CNT”). The CNT includes a plurality of carbon atoms combined with each other to form a tube shape of which diameter is about a few nanometers. CNTs are generally hollow cylindrical structures made up of carbon atoms having high strength and low weight. The name carbon “nano” tube is derived from their size, as nanotubes are on the order of only a few nanometers wide, and their length can be significantly greater than their width. The bonding structure of CNTs provide them with their unique strength. The CNTs naturally align themselves into “ropes” held together by Van der Waals force. The CNT has a good electrical conductivity and is very hard. Therefore, electrons are released easily. The CNT emits electrons when voltages of about 10V to about 50V are applied to the CNT.

The CNT is grown on the catalyst metal layer 330 to form the tips 340. The catalyst metal layer 330 helps the growing of the tips 340 including the CNT. The catalyst metal layer 330 may include, for example, nickel Ni, cobalt Co, iron Fe, a mixture thereof, etc.

The CNT may be grown on the catalyst metal layer 330 through a chemical vapor deposition (“CVD”) method to form the tips 340, although other methods of producing the CNT may be incorporated, such as, but not limited to, arc discharge and laser ablation. The CVD method, however, has been able to produce larger quantities of nanotube (compared to the other methods) at lower cost, thus enhancing productivity. This is usually done by reacting a carbon-containing gas (such as acetylene, ethylene, ethanol, etc.) with a metal catalyst, such as the catalyst metal layer 330 at high temperatures, such as temperatures above 600° C.

In one exemplary method, the third substrate 310 having the catalyst metal layer 330 formed thereon is dipped into hydrogen fluoride HF diluted by water for about 140 seconds. Then, nitrogen gas of about 100 sccm (standard cubic centimeters per minute, where “standard” means referenced to 0 degrees Celsius and 760 Torr) is blown toward the third substrate 310 at a temperature of about 950° C. for about 20 minutes to form catalyst metal particles on the third substrate 310. Then, hydrogen carbonized (C₂H₂) gas of about 20 sccm is blown toward the third substrate 310 having catalyst metal particles formed thereon for about 10 minutes to form the tips 340 of the CNT.

When the tips 340 of CNT are erect, such as substantially perpendicular to a face of the catalyst metal layer 330, the tips 340 emit more electrons.

A plurality of spacers 500 are interposed between the middle substrate 201 and the bottom substrate 300. Therefore, the middle substrate 210 and the bottom substrate 300 are spaced apart from each other by the spacers 500. The spacers 500 may be equally sized so as to provide even spacing between the middle substrate 201 and the bottom substrate 300. The length of the spacers 500 may be adjusted as necessary for adjusting an overall size of the display apparatus.

A space between the middle substrate 201 and the bottom substrate 300, as defined by the spacers 500, corresponds to a vacuum.

Referring to FIG. 3, when different driving voltages are applied to the anode electrode 240 and the cathode electrode 320, respectively, to generate electric fields between the anode electrode 240 and the cathode electrode 320, the tips 340 of CNT emit electrons. The electrons are accelerated by the electric fields to have higher energy and collide with the fluorescent layer 250 to generate light L1.

The light L1 passes through the middle substrate 201 by passing through the array substrate 220 and the pixel electrode 230, and an amount of the light L1 is adjusted by the liquid crystal layer 400 to be converted into image light containing images. The image light exits the display apparatus 601 through the top substrate 101 after passing by and through the common electrode 130 and the color filter layer 120.

In FIG. 1, the color filter layer 120 is formed, for example, on the light-entering surface of the first substrate 110 of the top substrate 101. Alternatively, the color filter layer 120 may be interposed between the array substrate 220 and the pixel electrode 230.

According to the exemplary embodiment, a light source is integrally formed with an LCD panel. Therefore, thickness is reduced and luminance is enhanced.

Furthermore, the array substrate 220 and the pixel electrode 230 are formed on an upper face (light exiting face) of the second substrate 210, and both of the anode electrode 240 and the fluorescent layer 250 are formed on a lower face (light entering face) of the second substrate 210. Therefore, no additional substrate for forming the anode electrode 240 and the fluorescent layer 250 is required, thereby reducing thickness of the display apparatus and enhancing luminance.

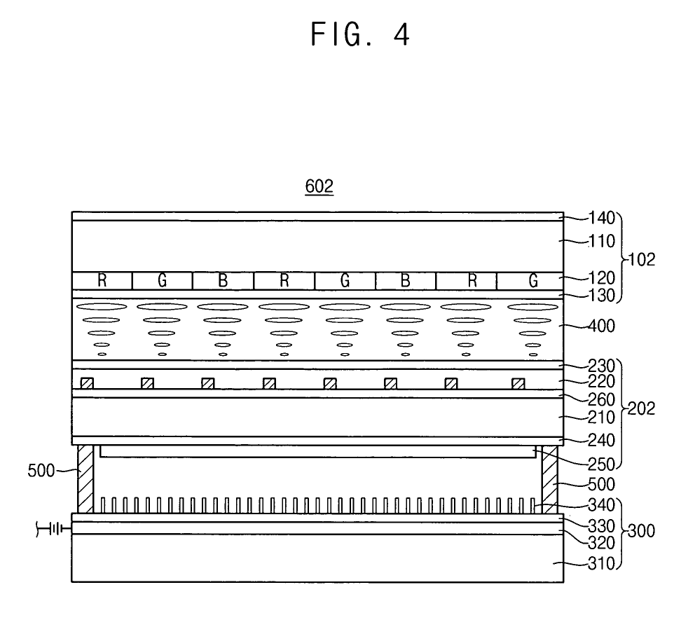

FIG. 4 is a schematic cross-sectional view illustrating a second exemplary embodiment of display apparatus according to the present invention. The display apparatus is the same as in the previous embodiment described with respect to FIG. 1 except for first and second polarization layers. Thus, the same reference numerals will be used to refer to the same or like parts as those described in the previous embodiment illustrated in FIG. 1, and any further explanation will be omitted.

Referring to FIG. 4, a display apparatus 602 includes a top substrate 102, a middle substrate 202, and a bottom substrate 300.

The top substrate 102 includes a first substrate 110, a color filter layer 120, a common electrode layer 130, and a first polarization layer 140.

The middle substrate 202 includes a second substrate 210, an array substrate 220, a pixel electrode 230, an anode electrode 240, a fluorescent layer 250, and a second polarization layer 260.

The first polarization layer 140 is formed on the first substrate 110. The first polarization layer 140 and the color filter layer 120 are formed on opposite faces of the first substrate 110, respectively, to each other. For example, the color filter layer 120 is formed on the light entering face of the first substrate 110, and the first polarization layer 140 is formed on the light exiting face of the first substrate 110. The second polarization layer 260 is interposed between the second substrate 210 and the array substrate 220.

The second polarization layer 260 polarizes the light L1 in FIG. 3 after it passes through the fluorescent layer 250, the anode electrode 240, and the second substrate 210, and the first polarization layer 140 analyzes the image light.

When the liquid crystal layer 400 includes twisted nematic liquid crystal molecules, the first and second polarization layers 140 and 260 may have polarization axes that are substantially perpendicular to each other such that unpolarized light enters the second polarization layer 260 and emerges polarized in the same plane as the local orientation of the liquid crystal molecules. The twisted molecules then rotate the plane of polarization by 90 degrees so that the light that reaches the first polarization layer 140 can pass through it.

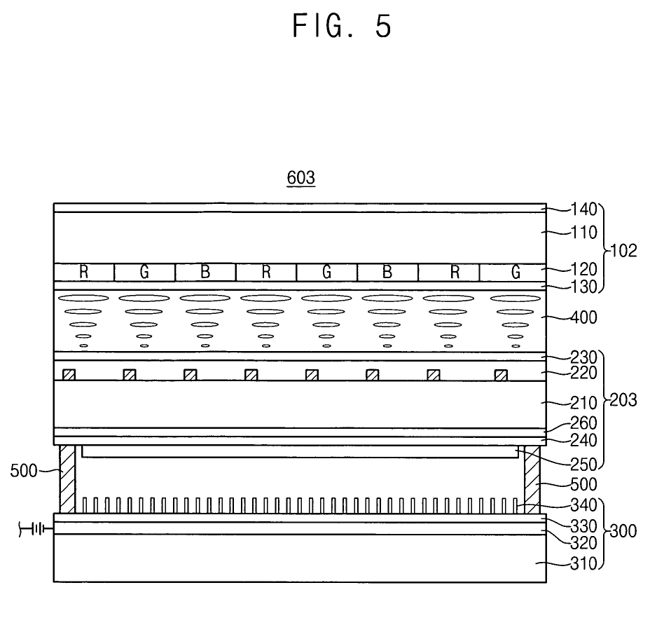

FIG. 5 is a schematic cross-sectional view illustrating a third exemplary embodiment of a display apparatus according to the present invention. The display apparatus is the same as in the previous embodiment described with respect to FIG. 4 except for a position of a second polarization layer. Thus, the same reference numerals will be used to refer to the same or like parts as those described with respect to FIG. 4, and any further explanation will be omitted.

Referring to FIG. 5 a display apparatus 603 includes a top substrate 102, a middle substrate 203, and a bottom substrate 300. The middle substrate 203 includes a second substrate 210, an array substrate 220, a pixel electrode 230, an anode electrode 240, a fluorescent layer 250, and a second polarization layer 260. The second polarization layer 260 is interposed between the second substrate 210 and the anode electrode 240 instead of between the second substrate 210 and the array substrate 220 as in FIG. 4. Thus, in this embodiment, the second polarization layer 260 is positioned on the light entering face of the second substrate 210 instead of the light exiting face of the second substrate 210.

The second polarization layer 260 polarizes the light L1 in FIG. 3.

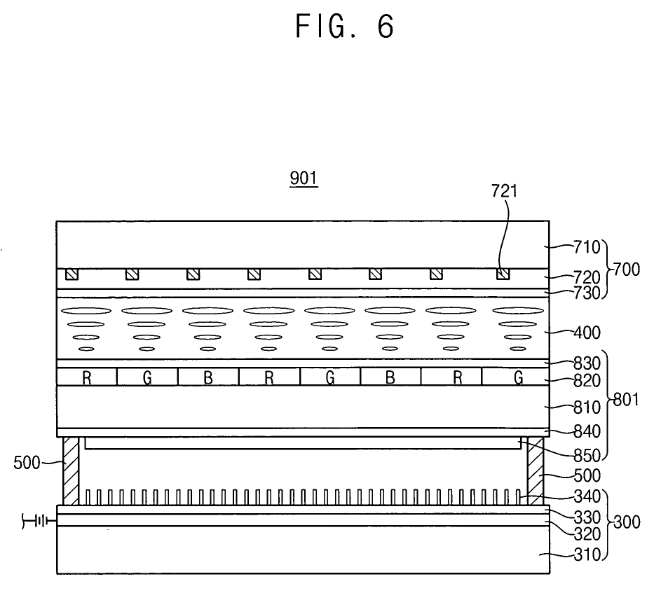

FIG. 6 is a schematic cross-sectional view illustrating a fourth exemplary embodiment of a display apparatus according to the present invention.

Referring to FIG. 6, a display apparatus 901 includes a top substrate 700, a middle substrate 801, a bottom substrate 300, a liquid crystal layer 400, and spacers 500.

The top substrate 700 includes a first substrate 710, an array substrate 720, and a pixel electrode 730. The array substrate 720 is formed on the first substrate 710 such that the array substrate 720 faces the middle substrate 801. Thus, the array substrate 720 is formed on the light entering face of the first substrate 710. The array substrate 720 includes a plurality of TFTs 721. The pixel electrode 730 is formed on the array substrate 720. Thus, light passes through the pixel electrode 730 prior to passing through the array substrate 720. A plurality of pixel regions including the TFTs 721 are arranged in a matrix shape on the first substrate 710. This arrangement differs from the prior embodiments in that the pixel electrode and array substrate are formed on the top substrate instead of the middle substrate.

The middle substrate 801 includes a second substrate 810, a color filter layer 820, a common electrode 830, an anode electrode 840, and a fluorescent layer 850. The color filter layer 820 is formed on the second substrate 810 such that the color filter layer 820 faces the top substrate 700. That is, the color filter layer 820 is disposed on a light exiting face of the second substrate 810. The common electrode 830 is formed on a light-exiting surface of the color filter layer 820 such that the color filter layer 820 is disposed between the common electrode 820 and the second substrate 810. The common electrode 830 has a uniform thickness. This arrangement differs from the prior embodiments in that the color filter layer and the common electrode are formed on the middle substrate instead of the top substrate.

The color filter layer 820 includes red, green, and blue color filters R, G and B. The red, green, and blue color filters R, G and B may be disposed alternately in that order. The red, green, and blue color filters R, G and B correspond to the pixel regions, respectively.

as in the prior embodiments, the anode electrode 840 is formed on the second substrate 810 such that the anode electrode 840 faces the bottom substrate 300. The fluorescent layer 850 is formed on the anode electrode 840.

The array substrate 720 and the pixel electrode 730 are formed on the first substrate 710, and the anode electrode 840 and the fluorescent layer 850 are formed on the second substrate 810. Therefore, the array substrate 720 and the pixel electrode 730 are not damaged by heat that is generated during manufacturing the anode electrode 840 and the fluorescent layer 850.

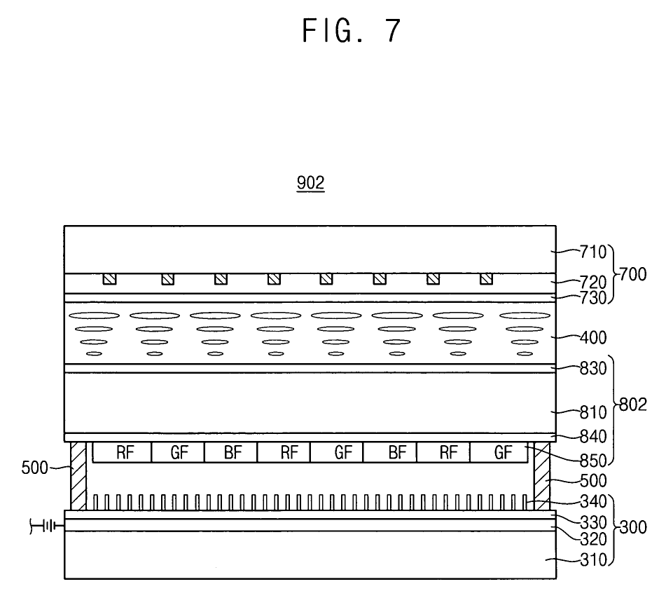

FIG. 7 is a schematic cross-sectional view illustrating a fifth exemplary embodiment of a display apparatus according to the present invention. The display apparatus is the same as in the previous embodiment described with respect to FIG. 6 except for color filter layers and fluorescent layer. Thus, the same reference numerals will be used to refer to the same or like parts as those described in the previous embodiment illustrated in FIG. 6, and any further explanation will be omitted.

Referring to FIG. 7, a display apparatus 902 includes a top substrate 700, a middle substrate 802, a bottom substrate 300, a liquid crystal layer 400, and spacers 500.

The middle substrate 802 includes a second substrate 810, a common electrode 830, an anode electrode 840, and a fluorescent layer 850. The common electrode 830 is formed on the second substrate 810 such that the common electrode 830 faces the top substrate 700. That is, the common electrode 830 is disposed on a light exiting face of the second substrate 810.

The anode electrode 840 is formed on the second substrate 810 such that the anode electrode 840 faces the bottom substrate 300. That is, the anode electrode 840 is disposed on a light entering face of the bottom substrate 300.

The fluorescent layer 850 is formed on the anode electrode 840. The fluorescent layer 850 includes a red fluorescent layer RF, a green fluorescent layer GF, and a blue fluorescent layer BF arranged in a pattern. Electrons emitted from the tips 340 of CNT collide with the red fluorescent layer RF, the green fluorescent layer GF, and the blue fluorescent layer BF and emit red, green, and blue lights, respectively.

The red fluorescent layer RF, the green fluorescent layer GF, and the blue fluorescent layer BF may be disposed alternately in that order. The red fluorescent layer RF, the green fluorescent layer GF, and the blue fluorescent layer BF correspond to the pixel regions, respectively.

The fluorescent layer 850 includes the red fluorescent layer RF, the green fluorescent layer GF, and the blue fluorescent layer BF. Therefore, the color filter layer 820 of FIG. 6 is not required and therefore not formed within this embodiments of a display apparatus, as a result, manufacturing process is simplified and thickness of the display device is further reduced.

The polarization layers of the prior embodiments may further be incorporated within the embodiments described with respect to FIGS. 6 and 7.

Furthermore, decay of light is prevented to enhance luminance of the light.

According to the display apparatuses of the present invention, a light source is integrally formed with an LCD panel. Therefore, a thickness of the display device is reduced and luminance of the light is enhanced.

Furthermore, the array substrate and the pixel electrode may be formed on an upper face of the second substrate, and both of the anode electrode and the fluorescent layer may be formed on a lower face of the second substrate. Therefore, no additional substrate for forming the anode electrode and the fluorescent layer is required resulting in a reduction of the display apparatus thickness and luminance enhancement.

Alternatively, the array substrate and the pixel electrode may be formed on the first substrate, and the anode electrode and the fluorescent layer may be formed on the second substrate. Therefore, the array substrate and the pixel electrode may not be damaged by heat that is generated during manufacturing the anode electrode and the fluorescent layer.

Additionally, the fluorescent layer may include the red fluorescent layer RF, the green fluorescent layer GF, and the blue fluorescent layer BF. Therefore, the color filter layer may not be formed. As a result, manufacturing process is simplified and thickness of the display device is reduced.

Furthermore, decay of light is prevented to enhance luminance of the light.

Having described the exemplary embodiments of the present invention and its advantages, it is noted that various changes, substitutions and alterations can be made herein without departing from the spirit and scope of the invention as defined by appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A display apparatus comprising:
a top substrate including a first substrate;
a middle substrate including a second substrate having an upper surface facing the first substrate and a lower surface opposite the upper surface, an array layer formed on the upper surface, an anode electrode formed on the lower surface, and a fluorescent layer formed on the anode electrode; and
a bottom substrate including a third substrate and a cathode electrode formed on the third substrate, the cathode electrode facing the fluorescent layer.

2. The display apparatus of claim 1, wherein the bottom substrate further comprises a plurality of tips formed on the cathode electrode, the tips emitting electrons when a voltage is applied to the cathode electrode.

3. The display apparatus of claim 2, wherein the tips include carbon nano tube.

4. The display apparatus of claim 3, wherein the bottom substrate further comprises a catalyst metal layer interposed between the tips and the cathode electrode.

5. The display apparatus of claim 4, wherein the catalyst metal layer includes nickel, cobalt, iron or a mixture thereof.

6. The display apparatus of claim 1, further comprising a spacer interposed between the middle substrate and the bottom substrate to space apart the bottom substrate from the middle substrate.

7. The display apparatus of claim 1, wherein the anode electrode comprises a material that is optically transparent and electrically conductive.

8. The display apparatus of claim 1, further comprising a liquid crystal layer interposed between the top substrate and the middle substrate.

9. The display apparatus of claim 8, wherein the array layer comprises:
a plurality of thin film transistors, each of the thin film transistors including a gate electrode, a source electrode, and a drain electrode; and
a protection layer that covers the thin film transistors and has a contact hole exposing the drain electrode.

10. The display apparatus of claim 9, wherein the middle substrate further comprises a pixel electrode formed on the protection layer and the pixel electrode is electrically connected to the drain electrode through the contact hole.

11. The display apparatus of claim 10, wherein the middle substrate further comprises a color filter layer interposed between the array layer and the pixel electrode.

12. The display apparatus of claim 1, wherein the top substrate further comprises:
a color filter layer formed on the first substrate, the color filter layer including a plurality of color filters; and
a common electrode formed on the color filter layer.

13. The display apparatus of claim 1, further comprising:
a first polarization member that polarizes a light that exits the top substrate; and
a second polarization member that polarizes a light that advances toward the top substrate.

14. The display apparatus of claim 13, wherein the second polarization member is disposed between the upper surface of the second substrate and the array layer.

15. The display apparatus of claim 13, wherein the second polarization member is disposed between the lower surface of the second substrate and the anode electrode.

16. The display apparatus of claim 1, further comprising a voltage, the fluorescent layer emitting a light when the voltage is applied to the cathode electrode.

17. The display apparatus of claim 16, wherein the fluorescent layer emits the light when electrons are emitted from the bottom substrate and collide with the fluorescent layer.

18. A display apparatus comprising:
a top substrate including a first substrate and an array layer formed on the first substrate;
a middle substrate including a second substrate having an upper surface facing the first substrate and a lower surface opposite the upper surface, an anode electrode formed on the lower surface, and a fluorescent layer formed on the anode electrode; and
a bottom substrate including a third substrate and a cathode electrode formed on the third substrate, the cathode electrode facing the fluorescent layer.

19. The display apparatus of claim 18, further comprising in the fluorescent layer:
a red fluorescent layer emitting red light when electrons emitted from the cathode collide with the red fluorescent layer;
a green fluorescent layer emitting green light when electrons emitted from the cathode collide with the green fluorescent layer; and
a blue fluorescent layer emitting blue light when electrons emitted from the cathode collide with the blue fluorescent layer, each of the red, green, and blue fluorescent layers arranged alternately, and each of the red, green, and blue fluorescent layers corresponds to a pixel region.

20. The display apparatus of claim 18, further comprising in the array layer:
a plurality of thin film transistors, each of the thin film transistors including a gate electrode, a source electrode, and a drain electrode; and
a protection layer that covers the thin film transistors and has a contact hole exposing the drain electrode.

21. The display apparatus of claim 20, wherein the top substrate further comprises a pixel electrode formed on the protection layer and the pixel electrode is electrically connected to the drain electrode through the contact hole.

22. The display apparatus of claim 18, wherein the middle substrate further comprises:
a color filter layer formed on the upper surface of the second substrate, the color filter layer including red, green, and blue color filters alternately arranged, each of the red, green, and blue color filters corresponding to a pixel region; and
a common electrode formed on the color filter layer.

23. The display apparatus of claim 18, wherein the bottom substrate further comprises a plurality of tips formed on the cathode electrode, the tips including carbon nano tube and emitting electrons when a voltage is applied to the cathode electrode.

24. The display apparatus of claim 23, wherein the bottom substrate further comprises a catalyst metal layer interposed between the tips and the cathode electrode.

25. The display apparatus of claim 18, further comprising a voltage, the fluorescent layer emitting a light when the voltage is applied to the cathode electrode.

26. The display apparatus of claim 25, wherein the fluorescent layer emits the light when electrons are emitted from the bottom substrate and collide with the fluorescent layer.

27. A display apparatus comprising:
a top substrate;
a middle substrate including a fluorescent layer; and,
a bottom substrate spaced from the middle substrate and including a cathode electrode facing the fluorescent layer, the fluorescent layer emitting a light when a voltage is applied to the cathode electrode.

28. The display apparatus of claim 27, further comprising a plurality of tips formed on the cathode electrode, the tips emitting electrons when the voltage is applied to the cathode electrode, the fluorescent layer emitting the light when the electrons collide with the fluorescent layer.

29. The display apparatus of claim 27, further comprising spacers spacing the middle substrate from the bottom substrate and a vacuum formed between the middle substrate and the bottom substrate.

30. The display apparatus of claim 27, further comprising an array layer having a plurality of thin film transistors formed on one of the top substrate and the middle substrate.

31. The display apparatus of claim 27, further comprising a color filter layer formed on one of the top substrate and the middle substrate.

32. The display apparatus of claim 27, further comprising:
a first polarization member that polarizes a light that exits the top substrate; and,
a second polarization member that polarizes a light that advances toward the top substrate.

33. The display apparatus of claim 27, further comprising, in the fluorescent layer:
red, green, and blue fluorescent layers emitting red, green, and blue light, respectively, when the fluorescent layer is impinged by electrons from the bottom substrate.
